(19) United States
(12) Patent Application Publication
(10) Pub. No.: US 2026/0235362 A1
(43) Pub. Date: Aug. 13, 2026

(54) Method for operating an annealing furnace

(71) Applicant: SMS group GmbH, Mönchengladbach (DE)

(72) Inventors: Thomas DAUBE, Duisburg (DE); Christian SPRUNG, Ratingen (DE); Markus LANGEJÜRGEN, Wipperfürth (DE)

(73) Assignee: SMS group GmbH, Mönchengladbach (DE)

(21) Appl. No.: 19/474,698

(22) PCT Filed: Mar. 19, 2024
(86) PCT No.: PCT/EP2024/057291

§ 371 Date: Oct. 11, 2025

(30) Foreign Application Priority Data
Apr. 18, 2023 (DE) 10 2023 203 508.1

(51) Int. Cl. F27B 9/24; F27B 9/40; F27D 19/00; F27D 99/00

(52) U.S. Cl. CPC F27B 9/2453; F27B 9/40; F27D 99/0006; F27D 2019/0003; F27D 2019/0059; F27D 2099/0015

(57) ABSTRACT

A method for operating an annealing furnace (100) for heating sheet metal is disclosed. The sheet metal is reciprocally transported through an inductive heating device (114) located within a heating zone (110) of the annealing furnace to inductively increase its surface temperature. The surface temperature of the sheet metal is detected upstream of or within the heating zone and compared with a predetermined limit value (TG). The reciprocating transport of the sheet metal through the inductive heating device is continued such that the surface temperature remains below the predetermined limit value (TG). When the surface temperature exceeds the predetermined limit value, a warning signal is output to indicate an overheating condition. The method enables controlled heating of the sheet metal while preventing excessive temperature rise and associated surface scaling.

### CROSS-REFERENCE TO RELATED APPLICATION

This application is a national stage application, filed under 35 U.S.C. § 371, of International Patent Application PCT/EP2024/057291, filed on Mar. 19, 2024, which claims the benefit of German Patent Application DE 10 2023 203 508.1, filed on Apr. 18, 2023.

### TECHNICAL FIELD

The invention relates to a method for operating an annealing furnace with a heating zone for heating sheet metal, in particular heavy plate or slabs.

### BACKGROUND

An annealing furnace and a method for operating the annealing furnace are generally known in the prior art, e.g. from Japanese patent application JP 2005146393 A. This Japanese publication describes how a steel sheet is uniformly heated by being transported reciprocally through an inductive heating device. In particular, the surface of the sheet metal is heated due to what is known as the skin effect.

The method for operating an annealing furnace known from the Japanese patent application has the disadvantage that it offers no protection against overheating and thus against excessive scale formation on the sheet metal.

### SUMMARY

The disclosure is based on the object of further developing a known method for operating a known annealing furnace for heating sheet metal in such a way that overheating of the sheet metal and thus undesirable excessive scale formation on the surface of the sheet metal is effectively prevented.

This object is solved by the method as claimed. Accordingly, the method comprises the following steps:
a) Reciprocal transport of the sheet metal through an inductive heating device within the heating zone of the annealing furnace in order to inductively increase the surface temperature of the sheet metal;
b) Detecting the surface temperature of the sheet metal within the heating zone;
c) Comparing the detected surface temperature with a predetermined limit value for the surface temperature; and
d) Carrying out the reciprocal transport of the sheet metal through the inductive heating device only as long as the limit value for the surface temperature is not exceeded; or
d′) Issuing a warning signal, in particular to a control device or a control centre of the annealing furnace, if the limit value for the surface temperature of the sheet metal is exceeded.

The claimed method steps advantageously ensure that the surface temperature of the sheet metal is not exceeded during the reciprocal passage through the inductive heating device. The limit value to be observed for the surface temperature of the sheet metal is selected in such a way that overheating of the sheet metal and thus undesirable scale formation on its surface is effectively prevented or at least reduced.

The claimed reciprocal passage of the sheet metal through the heating device also offers the advantage that the annealing furnace can be constructed in a significantly shorter way to achieve a desired temperature increase than if the sheet metal were transported through the furnace only in one direction.

The use of the inductive heating device and thus the use of electric energy instead of fossil energy, as would be required with a gas-powered heating device, offers the possibility of effectively reducing CO2 emissions and other emissions, such as nitrogen oxides. Furthermore, the inductive heating device offers the advantage that it can be switched very quickly between an operating mode and a standby mode, and its energy consumption is therefore significantly lower than if the heating device were permanently switched on.

The term “sheet metal” includes both heavy plate and slabs as well as cut-off portions of a casting strand.

Further advantageous embodiments of the method according to the invention for operating an annealing furnace are the subject matter of the dependent claims.

### BRIEF DESCRIPTION OF THE DRAWINGS

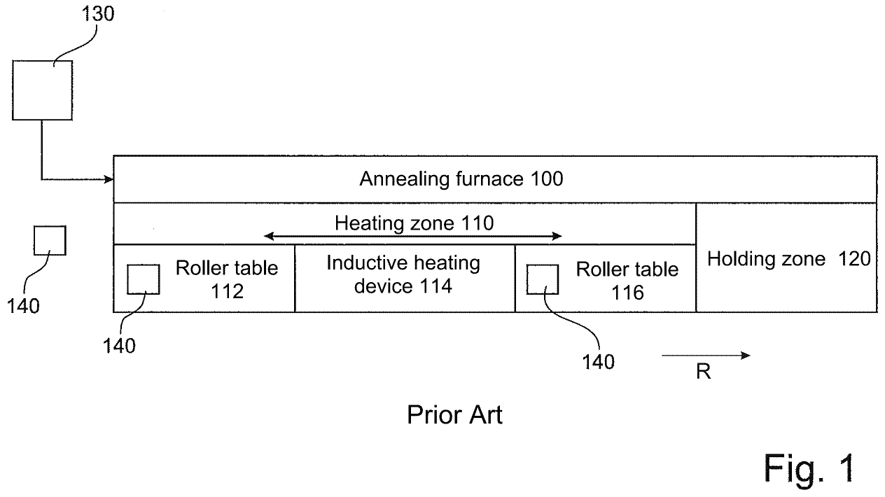

A single FIG. 1 is attached to the description, which shows a prior art annealing furnace as required for carrying out the method according to the invention.

### DETAILED DESCRIPTION

This annealing furnace is described in more detail below with reference to FIG. 1.

FIG. 1 shows the structure of an annealing furnace 100. It consists of a heating zone 110 and a holding zone 120 arranged downstream in the transport direction R for a passing sheet. The heating zone 110 is in turn divided into an inductive heating device 114, upstream of which in the transport direction R is a roller conveyor 112 and downstream of which in the transport direction R is a roller conveyor 116. The two roller conveyors 112, 116 are used for reciprocal operation of the heating zone, i.e. for reciprocal transport of a sheet through the inductive heating device 114. Temperature measuring devices 140, for example in the form of pyrometers, may be provided upstream of the heating zone 110 and/or in at least one of the roller conveyors 112, 116 for locally detecting the temperature of the sheet metal in each case. In addition, a control device 130 is assigned to the annealing furnace 100 for adjusting certain operating parameters of the annealing furnace, e.g. the temperature distribution and/or the atmosphere within the inductive heating device 114 and the holding zone 120. In addition, the control device 130 serves to control the reciprocal transport of the sheet metal within the heating zone and to subsequently control the transport of the sheet metal through the holding zone 120. A lock, not shown in FIG. 1, may be provided between the heating zone 110 and the holding zone 120 if the heating zone and the holding zone are operated with different atmospheres.

The novel method for operating such an annealing furnace is described below:

In its basic form, it comprises the following steps:
a) Reciprocally transporting the sheet metal through an inductive heating device 114 within the heating zone 110 of the annealing furnace 100 in order to inductively increase the surface temperature of the sheet metal;
characterised by
b) Detecting the surface temperature TO of the sheet metal upstream of and/or within the heating zone 110;
c) Comparing the detected surface temperature TO with a predetermined limit value TG for the surface temperature; and
d) Carrying out the reciprocal transport of the sheet metal through the inductive heating device 114 only as long as the limit value TG for the surface temperature is not exceeded; or
d′) Outputting a warning signal, in particular to a control device 130 or a control centre of the annealing furnace 100, if the limit value TG for the surface temperature of the sheet metal is exceeded.

According to a first exemplary embodiment, the method provides that during method step d), the sheet metal is transported with its entire length out of the inductive heating device 114 onto a roller conveyor 112, 116 upstream or downstream of the heating device as part of the heating zone 110 of the annealing furnace 100. This embodiment of method step d) advantageously ensures that all areas of the sheet metal, in particular its head and foot portions, are heated to a uniform temperature like the middle portion of the sheet metal.

In order to ensure that the specified limit temperature for the surface of the sheet metal to be heated is not exceeded, it is important to detect the current surface temperature TO of the sheet metal in accordance with method step b) upstream of and/or within the heating zone and to compare it with the specified limit value TG for the surface temperature; see method step c). In addition, in order to comply with the limit value TG, it is necessary that during method step d)—based on the currently detected surface temperature T0—the respective increase n*ΔT in the surface temperature that the sheet metal would experience if it were to pass through the inductive heating device 114 at least one more time n, starting from one of the roller conveyors 112, 116, is calculated in advance. A distinction must be made between the following two cases:

If the sheet metal is stored as a starting point on the roller conveyor 112 upstream of the heating device in accordance with a first case, it would be necessary to calculate in advance how large the increase n*ΔT in the surface temperature of the sheet metal would be if the sheet metal were to be passed through the inductive heating device 114 an odd number n of times, in particular one more time.

The odd number n of passages is justified in the first case by the fact that the sheet metal must land on the roller conveyor 116 downstream of the heating device 114 after the n passages.

The second case to be considered is that in which the sheet metal is located on the roller conveyor 116 downstream of the heating device 114 in the transport direction R as the starting point. In this case, it is necessary to calculate in advance what effects this would have on the surface temperature of the sheet metal if the sheet metal were to be transported through the inductive heating device 114 an even number n of times, at least two more times.

The even number n of passages is justified in this second case by the fact that the sheet metal must land on this roller conveyor 116 again after the n passages.

After the n passages, in both cases the sheet metal is transported from the roller conveyor 116 downstream of the heating device 114 in the transport direction R without further heating into the downstream holding zone 120. For this n-fold passage through the heating device 114, compliance with the limit temperature TG must first be calculated in advance according to the following formula:

$$T 0 + n * Δ T \underline{<} T G \qquad ( 1 )$$

If the calculation of the limit temperature TG according to formula (1) shows that this limit temperature would be maintained in the case of n-fold passage of the sheet metal through the inductive heating device 114, method step d) would take effect and the pre-calculated n passages of the sheet metal through the heating device 114 could take place as pre-calculated.

If the increase n*ΔT in the surface temperature according to formula (1) starting from T0 is so large that the limit value for the surface temperature of the sheet metal would be exceeded in the case of the aforementioned n-fold passage through the inductive heating device 114, i.e. T0+n*ΔT>TG would apply, then method step d′) would take effect, whereby a signal would be output to, in particular, a control device 130 or a control centre of the annealing furnace 100. The control device must then, at least during individual passages, either switch off the inductive heating device 114 or reduce the temperature in the inductive heating device 114 to such an extent that, at the end, after n passages, the specified limit value TG for the surface temperature of the sheet metal is not exceeded.

To transport the sheet metal from the heating zone 110 to the downstream holding zone 120 of the annealing furnace 100, the transport speed of the sheet metal is preferably increased to a speed between 0.5 m/sec and 1 m/sec. This has the advantage that the transition of the sheet metal from one area to the other is carried out quickly and the atmospheres are not unnecessarily mixed. An increased oxygen content in the holding zone can lead to increased scaling.

The aforementioned limit value TG for the surface temperature of the sheet metal is set at 700° C., preferably at 650° C. or, more preferably, at 600° C. This setting is material-dependent and effectively prevents scaling of the surface of the sheet metal; preferably, scaling is at least significantly reduced below these temperatures.

The aforementioned detection of the surface temperature T0 of the sheet metal in accordance with method step d) is preferably carried out contactlessly using a pyrometer as a temperature detection device 140. The temperature detection device is preferably arranged upstream of the entrance to the heating zone 110, in the area of the roller conveyor 112 upstream of the heating device 114 or in the area of the roller conveyor 116 downstream of the heating device 114.

Due to the comparatively low temperatures within the heating zone 110, in particular due to the temperatures there being below the limit value TG for the surface temperature, it is advantageously possible to provide a non-inert gas atmosphere, preferably air, within the heating zone 110 without further increasing the risk of scaling of the sheet metal. Only in the heating zone, in which the sheet metal would be further heated after passing through heating zone 110, does it make sense to provide an inert gas atmosphere.

During the execution of method step d), i.e. while the sheet metal is in the heating zone 110, the average sheet metal temperature TM is increased to above 550° C., for example; this is the result of the n-fold passage of the sheet metal through the inductive heating device 114.

The time taken for the sheet metal to pass through the inductive heating device 114 is at least 5 times, preferably 10 times, shorter than the time required for conventional gas-fired preheating of the sheet metal. This results in smaller differences between the head and foot temperatures of the sheet metal.

The number of required passages for the sheet metal through the heating device depends on the thickness of the sheet metal. For example, a thickness of 5 mm requires approximately 5-10 passages through the heating device, while a thickness of 20 mm requires approximately 20 passages.

The inductive heating device 114 is preferably operated with an alternating current with a frequency of 1-10 kHz. The corresponding alternating current sources are available anyway; below 1 kHz, the induction systems generate unpleasant noise levels.

### LIST OF REFERENCE NUMERALS

100 Annealing furnace
110 Heating zone
112 Roller conveyor
114 Heating device
116 Roller conveyor
120 Holding zone
130 Control device
140 Temperature measuring device, e.g. pyrometer
R Transport direction of the sheet metal from the heating zone to the holding zone
TG Limit value for the surface temperature of the sheet metal
TM Average sheet metal temperature
T0 Current surface temperature of the sheet metal
ΔT Increase in surface temperature per passage through the inductive heating device
n Number of passages of the sheet metal through the heating device

1.-12. (canceled)

13. A method for operating an annealing furnace (100) for heating sheet metal, comprising:
a) reciprocally transporting the sheet metal through an inductive heating device (114) within a heating zone of the annealing furnace (100) to inductively increase a surface temperature of the sheet metal;
b) detecting the surface temperature of the sheet metal upstream of or within the heating zone (110);
c) comparing the surface temperature with a predetermined limit value (TG) for the surface temperature;
d) continuing reciprocating transport of the sheet metal through the inductive heating device (114) such that the predetermined limit value (TG) for the surface temperature is not exceeded; and
d′) outputting a warning signal when the predetermined limit value (TG) for the surface temperature of the sheet metal is exceeded.

14. The method according to claim 13,
wherein outputting the warning signal includes outputting the warning signal to a control device (130) or a control centre of the annealing furnace (100).

15. The method according to claim 13,
wherein the continuing reciprocating transport of the sheet metal includes transporting the sheet metal entirely out of the inductive heating device (114) onto a roller conveyor (112, 116) upstream or downstream of the inductive heating device.

16. The method according to claim 15, further comprising
calculating in advance, during the continuing reciprocating transport, based on a current surface temperature (T0) of the sheet metal, an increase n*ΔT in the surface temperature that the sheet metal will experience if,
according to a first case—starting from the roller conveyor (112) arranged upstream of the inductive heating device (114)—it were transported through the inductive heating device (114) an odd number (n) of times, at least one more time, or if,
according to a second case—starting from the roller conveyor (116) arranged downstream of the inductive heating device (114)—it were transported through the inductive heating device (114) an even number (n) of times, at least two more times; and
wherein the continuing reciprocating transport is carried out if, based on the advance calculation, the following applies:
$$T 0 + n * Δ T \underline{<} TG ; and \qquad ( 1 )$$
wherein the outputting the warning signal is carried out if, based on the advance calculation, the following applies:
$$T 0 + n * Δ T > T G \qquad ( 2 )$$
where n∈N: Number of passages through the inductive heating device.

17. The method according to claim 16, wherein
a control device (130), in response to the warning signal in the first case or the second case, switches off the inductive heating device (114) or reduces its temperature to such an extent that a further n-fold passage of the sheet metal through the inductive heating device is possible without exceeding the limit value TG; or
the control device (130), in response to the warning signal in the second case, ends the continuing reciprocating transport without further passage of the sheet metal through the inductive heating device (114) and transports the sheet metal from the heating zone (110) into a downstream holding zone (120) of the annealing furnace (100).

18. The method according to claim 17,
wherein, in order to transport the sheet metal from the heating zone (110) to the downstream holding zone (120) of the annealing furnace (100), a transport speed of the sheet metal is increased to between 0.5 m/s and 1 m/s.

19. The method according to claim 13,
wherein the predetermined limit value (TG) for the surface temperature of the sheet metal is 600° C., 650° C., or 700° C.

20. The method according to claim 15, wherein
detecting the surface temperature of the sheet metal is performed contactlessly using a pyrometer, upstream of an entrance to the heating zone (110), in an area of the roller conveyor (112) upstream of the inductive heating device (114), or an area of the roller conveyor (116) downstream of the inductive heating device (114).

21. The method according to claim 17,
wherein an atmosphere within the heating zone (110) is air; and
wherein an inert gas atmosphere prevails within the holding zone (120).

22. The method according to claim 13, wherein
an average sheet metal temperature (TM) is increased to TM>550° C. during the continuing reciprocating transport.

23. The method according to claim 13,
wherein a pass time of the sheet metal through the inductive heating device (114) is at least 5 times shorter than a preheating time required for preheating the sheet metal.

24. The method according to claim 13, wherein
a number (n) of passes performed during the continuing reciprocating transport is selected depending on a thickness of the sheet metal as follows:

| Thickness | Number n of passes |
|---|---|
| 5 mm | 5-10 |
| 20 mm | 20 |

25. The method according to claim 13, wherein
the inductive heating device (114) is operated with alternating current with a frequency of 1-10 Hz.
